(19) United States
(12) Patent Application Publication
(10) Pub. No.: US 2015/0096675 A1
(43) Pub. Date: Apr. 9, 2015

(54) SYSTEM AND METHOD FOR APPLYING TUBULAR SHRINK SLEEVE MATERIAL TO CONTAINERS

(71) Applicants: Adam W. Duncan, Apex, NC (US); Stephen L. Wiedmann, Boerne, TX (US); Glynn R. Bartlett, Boerne, TX (US)

(72) Inventors: Adam W. Duncan, Apex, NC (US); Stephen L. Wiedmann, Boerne, TX (US); Glynn R. Bartlett, Boerne, TX (US)

(21) Appl. No.: 14/470,427

(22) Filed: Aug. 27, 2014

Related U.S. Application Data
(60) Provisional application No. 61/887,663, filed on Oct. 7, 2013.

(51) Int. Cl. B65C 3/06; B65C 9/02; B65C 9/18; B65C 9/00

(52) U.S. Cl. CPC B65C 3/065; B65C 9/0065; B65C 9/02; B65C 9/1807
USPC 156/256; 156/517; 156/367

(57) ABSTRACT

Aa machine for applying tubular film to products includes a mandrel assembly about which tubular film is passed. The mandrel assembly includes a film cutter for cutting the tubular film into lengths sized for application to containers passing below the mandrel assembly. A sleeve ejection arrangement is associated with the mandrel assembly and includes a mechanism that moves linearly while engaging a cut length of film so as to eject the cut length of film from the mandrel assembly and onto a container. The mechanism may be arranged so as to also impart rotation to the cut length of film as it is ejected.

### CROSS-REFERENCES

This application claims the benefit of U.S. Provisional Application Ser. No. 61/887,663, files Oct. 7, 2013, which is incorporated herein be reference.

### TECHNICAL FIELD

The present application relates generally to machines that apply tubular shrink sleeve material to containers and, more particularly, to a system and method for ejecting tubular shrink sleeve material from a mandrel and onto containers.

### BACKGROUND

Tubular shrink sleeve application devices commonly utilize a mandrel over which a tubular shrink film is moved for cutting, and then the cut sleeve-type label is ejected from the mandrel onto a container located below the mandrel. A downstream application of heat can then be used to shrink the film.

Typically sleeve films used in such machines have a thickness of, for example, between 40 and 60 microns. However, industry is trending more and more toward lighter weight sleeve films, such as those having a thickness of about 20 microns. Such thinner sleeve films have a greater tendency to collapse upon themselves once ejected, interfering with proper placement of the sleeves over containers. As recognized in Japanese Patent Application No. JP-98973, published as early as 1988, one way to eject tubular sleeves in a manner the reduces the likelihood of the tubular sleeve collapsing is to rotate the sleeve during ejection. The rotational movement of the sleeve helps the sleeve maintain its expanded shape. JP-98973 teaches the use of air flows to create both the linear movement of the sleeve off of the mandrel and the rotational movement of the sleeve during ejection.

In light of the teachings of JP-98973, one readily apparent manner of achieving a similar sleeve ejection would be to skew the rotating wheels of long known prior art sleeve ejectors so that the wheels impart not only the linear movement, but also the rotational movement.

However, it would be desirable and advantageous to provide a system and method that does not use a rotating driver to eject the sleeve.

### SUMMARY

In one aspect, a machine for applying tubular film to products includes a mandrel assembly about which tubular film is passed. The mandrel assembly includes a film cutter for cutting the tubular film into lengths sized for application to containers passing below the mandrel assembly. A sleeve ejection arrangement is associated with the mandrel assembly and includes a mechanism that moves linearly while engaging a cut length of film so as to eject the cut length of film from the mandrel assembly and onto a container.

In one implementation, the mechanism comprises and elongated pad member that is reciprocated.

In one implementation, a linear actuator is connected to reciprocate the pad member.

In one implementation, the linear actuator is one of an air controlled member, a hydraulic controlled member or an electrically controlled member.

In one implementation, the linear actuator is an electrically controlled member that is one of a solenoid controlled member or a servomotor controlled member.

In one implementation, the pad member is spaced from a primary external surface of the mandrel assembly, the mandrel assembly includes a secondary surface that protrudes from the primary surface, and the film is engaged between the pad member and the secondary surface during ejection.

In one implementation, the secondary surface is a movable bearing surface.

In one implementation, the secondary surface is a stationary low friction surface material.

In one implementation, the elongated pad member is reciprocated in a linear direction that is skewed relative to a primary axis of the mandrel assembly such that the cut length of film is rotated as it is ejected from the mandrel assembly.

In one implementation, a skew angle of the linear direction relative to the primary axis is between about five degrees and about twenty-five degrees.

In one implementation, the elongated pad member has a length of between about 0.70 inches and about 1.00 inches.

In one implementation, the pad member is retractable away from the outer surface of the mandrel assembly.

In one implementation, the mechanism comprises a belt system, and a portion of the belt that is moving linearly between two belt sheaves engages the cut length of film for ejection.

In one implementation, the belt portion is spaced from a primary external surface of the mandrel assembly, the mandrel assembly includes a secondary surface that protrudes from the primary surface, and the film is engaged between the belt portion and the secondary surface during ejection.

In one implementation, the secondary surface is a movable bearing surface.

In one implementation, the secondary surface is a stationary low friction surface material.

In one implementation, the belt portion moves in a linear direction that is skewed relative to a primary axis of the mandrel assembly such that the cut length of film is rotated as it is ejected from the mandrel assembly.

In one implementation, a skew angle of the linear direction relative to the primary axis is between about five degrees and about twenty-five degrees.

In one implementation, a length of the belt portion that contacts that film is between about 0.70 inches and about 1.00 inches.

In another aspect, a method of applying tubular film sleeves onto containers involves: moving tubular film from a supply of tubular film over a mandrel assembly including a film cutter for cutting the tubular film to produce a tubular film sleeve sized for application to a container passing below the mandrel assembly; and contacting the tubular film sleeve with an eject mechanism that moves linearly while engaging the tubular film sleeve so as to push the tubular film sleeve off of a lower end of the mandrel assembly and onto the container.

In one implementation of the method, the eject mechanism moves in a linear direction that is skewed relative to a primary axis of the mandrel assembly such that the tubular film sleeve is also rotated as it is pushed off of the mandrel assembly.

In one implementation of the method, a skew angle of the linear direction relative to the primary axis is between about five degrees and about twenty-five degrees.

The details of one or more embodiments are set forth in the accompanying drawings and the description below. Other features, objects, and advantages will be apparent from the description and drawings, and from the claims.

### BRIEF DESCRIPTION OF THE DRAWINGS

FIG. 1 is a schematic side elevation of a tubular shrink sleeve applying apparatus;

FIGS. 2A and 2B show schematic partial side elevations depicting sleeve ejection according to one embodiment;

FIG. 3 shows a schematic partial side elevation of a skewed sleeve ejector; and

FIGS. 4A and 4B show schematic partial side elevations depicting sleeve ejection according to another embodiment.

### DETAILED DESCRIPTION

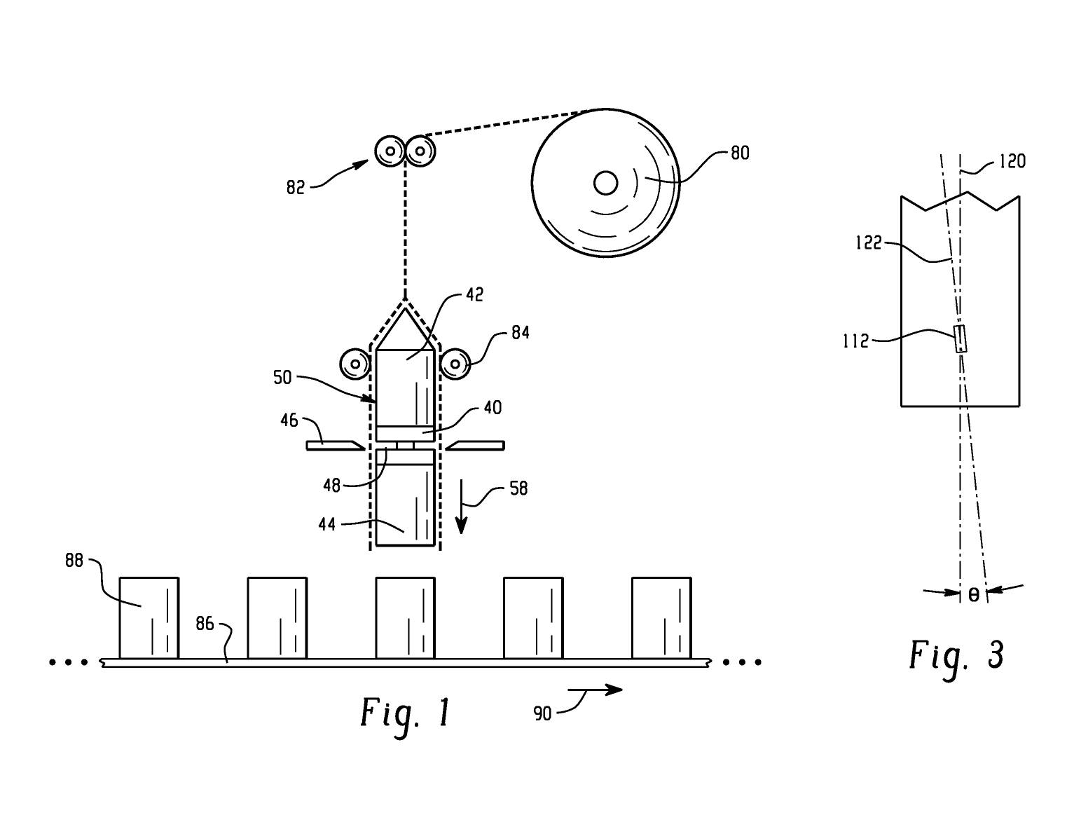

An exemplary tubular shrink sleeve applying apparatus is shown in schematic form in FIG. 1 and includes a roll 80 or other supply of tubular film that delivers the film to a pair of tubular film drivers 82 located above the tooling mandrel 50 for moving the film down toward the mandrel. The top of the tooling mandrel is shaped to cause the tubular film to spread from its flat orientation to an expanded orientation as it moves down around the mandrel 50. A set of film drive rollers 84 control feeding of the film downward along the mandrel (e.g., per arrow 58) toward a cutting mechanism 46 that is aligned with a cutting slot 48 in the external surface of the tooling mandrel. Sleeve drivers 84 operate in coordination with drivers 82 and interact with rollers in the sleeve drive slots to move the tubular film downward along the mandrel assembly. A container conveyance mechanism 86 passes beneath the mandrel and carries containers 88 in a conveyance direction 90 such that cut sleeves are moved off the mandrel assembly and onto the containers passing thereby. A downstream application of heat can then be used to shrink the film. Other variations of the apparatus are possible, including embodiments that do not include the film drivers 82.

In one embodiment, the tooling mandrel may be of a multi-component type including an upper part 42, lower part 44 and a cutting insert 40 as described in U.S. Pat. No. 8,613,183, commonly assigned to the assignee of the present application, and which is incorporated herein by reference. However, other tooling mandrel types and configurations are contemplated for use in connection with the innovative sleeve ejection arrangement of the present application, which is described in detail below.

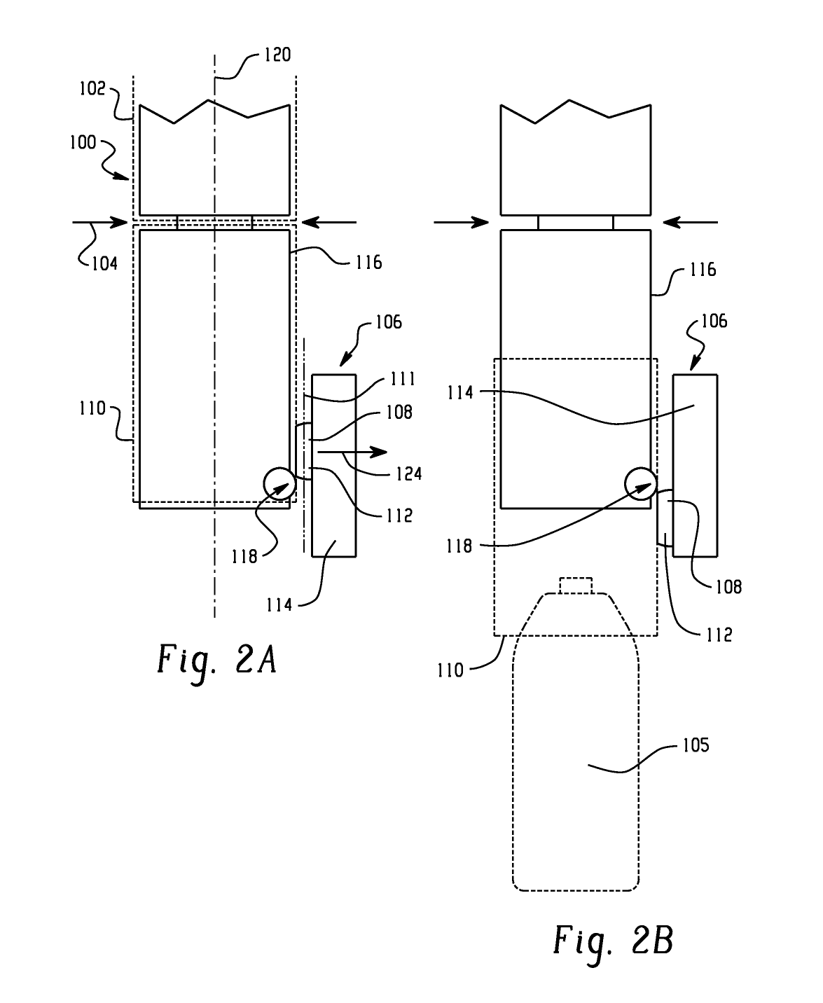

Referring not to FIGS. 2A-2B, in one embodiment, a machine for applying tubular film to products includes a mandrel assembly 100 about which tubular film 102 is passed. The mandrel assembly includes a film cutter 104 for cutting the tubular film into lengths sized for application to containers 105 passing below the mandrel assembly. A sleeve ejection arrangement 106 is associated with the mandrel assembly and includes a mechanism 108 that moves linearly while engaging a cut length 110 of film so as to eject the cut length of film from the mandrel assembly and onto the container.

The illustrated mechanism 108 includes an elongated pad member 112 that is reciprocated back and forth along its linear path 111 (in the case vertically oriented) for repeatedly ejecting sleeves. Any suitable linear movement mechanism 114 may be used for such purpose. In one example, mechanism 114 includes a linear actuator that is connected to reciprocate the pad member. By way of example, the linear actuator may be any one of an air controlled member, a hydraulic controlled member or an electrically controlled member. Where the linear actuator is an electrically controlled member it may be one of a solenoid controlled member or a servomotor controlled member.

In the illustrated embodiment, the pad member 112 is spaced from a primary external surface 116 of the mandrel assembly, and the mandrel assembly includes a secondary surface 118 that protrudes from the primary surface. The film is engaged between the pad member and the secondary surface during ejection. The secondary surface may be a movable bearing surface. However, the secondary surface may also be a stationary surface (e.g., formed of a low friction surface material). The spacing between the pad member 112 and the primary surface 116 allows each cut sleeve to pass downward beyond the upper end of the pad member after being cut and before ejection as shown in FIG. 2A. The elongated pad member 112 may be reciprocated in a direction that is parallel with a primary axis 120 of the mandrel assembly to impart only a vertically downward ejection motion to the sleeve.

Alternatively, as suggested in the schematic side elevation view of the embodiment of FIG. 3, the elongated pad member may 112 may be reciprocated in a linear direction (e.g., along axis 122) that is skewed relative to the primary axis 120 of the mandrel assembly, such that cut length of film is also rotated as it is ejected downward from the mandrel assembly. In one implementation, an angle of reciprocation of the pad member 112 relative to the primary axis 112 (or the skew angle between axis 122 and axis 112) is between about five degrees and about twenty-five degrees. However, generally any angle less than about 45 degrees may work depending upon the exact film being used and the speed of ejection required etc.

In one implementation, the elongated pad member 112 may have a length of between about 0.70 inches and about 1.00 inches to provide the best results. However, variations in length are possible. In the skewed orientation of FIG. 3, the length of the pad member will general correspond to the contact length on the film. In certain implementations, the pad member 112 may also be retractable away from the outer surface of the mandrel assembly (e.g., per arrow 124). For example, the body of mechanism 114 may include a solenoid or other actuator for retracting and extending the pad member, with the pad member typically being extended during linear movement to eject a cut sleeve and with the pad member typically being retracted for the return movement to a position awaiting the next cut sleeve.

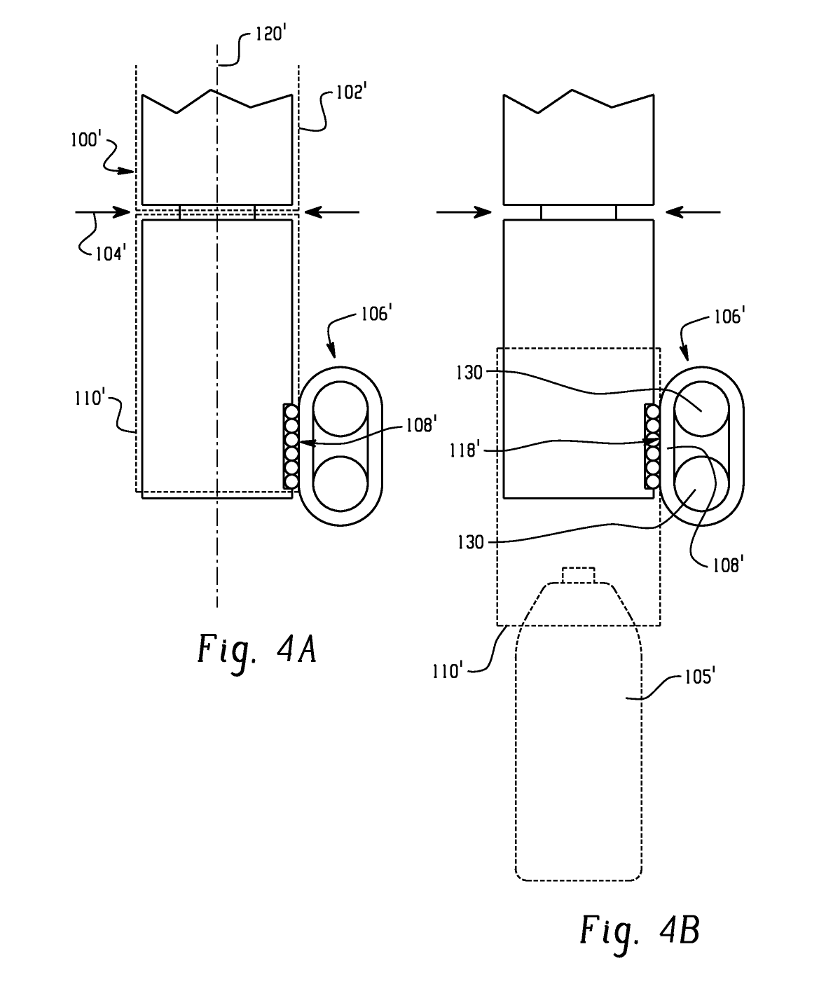

Referring to FIGS. 4A and 4B, in another embodiment the mandrel assembly 100′ includes an eject arrangement 106′ downstream of a film cutter 104′ for cutting the film 102′ The eject arrangement 106′ is formed by a belt system, and a portion or segment 108′ of the belt that is moving linearly between two belt sheaves 130 engages the cut length of film 110′ for ejection. Thus, the belt segment 108′ acts as the linearly moving mechanism that ejects the cut sleeve onto a container 105′. In the illustrated embodiment, the belt portion 108′ is spaced from the primary external surface 116′ of the mandrel assembly 100′, and the mandrel assembly includes a secondary surface 118′ that protrudes from the primary surface. The film is engaged between the belt portion 108′ and the secondary surface 118′ during ejection. In the illustrated embodiment the secondary surface is movable bearing surface (e.g., formed by a series of bearings). However, the secondary surface may be a stationary surface (e.g., of a low friction surface material).

The belt portion 108′ may be moved in a direction that is parallel with a primary axis 120′ of the mandrel assembly during sleeve ejection. Alternatively, the belt portion may move in a direction that is skewed relative to the primary axis 120′ (e.g., similar to that shown in FIG. 3) of the mandrel assembly such that cut length of film is also rotated as it is ejected from the mandrel assembly. The position and orientation of the sheaves 130 sets the angle of skew. In one implementation, the angle may be between about five degrees and about twenty-five degrees. However, generally any angle less than about 45 degrees may work depending upon the exact film being used and the speed of ejection required etc.

In one implementation, a length of the belt portion 108′ that contacts that film is between about 0.70 inches and about 1.00 inches. However, variations are possible.

Thus, the above described embodiments provide an advantageous method of applying tubular film sleeves onto containers by moving tubular film from a supply of tubular film over a mandrel assembly including a film cutter for cutting the tubular film to produce a tubular film sleeve sized for application to a container passing below the mandrel assembly, and contacting the tubular film sleeve with an eject mechanism that moves linearly while engaging the tubular film sleeve so as to push the tubular film sleeve off of a lower end of the mandrel assembly and onto the container. In certain embodiments, the eject mechanism moves in a linear direction that is skewed relative to a primary axis of the mandrel assembly such that the tubular film sleeve is also rotated as it is pushed off of the mandrel assembly. By way of example, a skew angle of the linear direction relative to the primary axis may between about five degrees and about twenty-five degrees.

It is to be clearly understood that the above description is intended by way of illustration and example only, is not intended to be taken by way of limitation, and that other changes and modifications are possible.

What is claimed is:

1. A machine for applying tubular film to products, the machine including:
a mandrel assembly about which tubular film is passed, the mandrel assembly including a film cutter for cutting the tubular film into lengths sized for application to containers passing below the mandrel assembly;
a sleeve ejection arrangement associated with the mandrel assembly, the sleeve ejection arrangement including a mechanism that moves linearly while engaging a cut length of film so as to eject the cut length of film from the mandrel assembly and onto a container.

2. The machine of claim 1 wherein the mechanism comprises and elongated pad member that is reciprocated.

3. The machine of claim 2 wherein a linear actuator is connected to reciprocate the pad member.

4. The machine of claim 3 wherein the linear actuator is one of an air controlled member, a hydraulic controlled member or an electrically controlled member.

5. The machine of claim 3 wherein the linear actuator is an electrically controlled member that is one of a solenoid controlled member or a servomotor controlled member.

6. The machine of claim 2 wherein the pad member is spaced from a primary external surface of the mandrel assembly, the mandrel assembly includes a secondary surface that protrudes from the primary surface, and the film is engaged between the pad member and the secondary surface during ejection.

7. The machine of claim 6 wherein the secondary surface is a movable bearing surface.

8. The machine of claim 6 wherein the secondary surface is a stationary low friction surface material.

9. The machine of claim 2 wherein the elongated pad member is reciprocated in a linear direction that is skewed relative to a primary axis of the mandrel assembly such that the cut length of film is rotated as it is ejected from the mandrel assembly.

10. The machine of claim 9 wherein a skew angle of the linear direction relative to the primary axis is between about five degrees and about twenty-five degrees.

11. The machine of claim 2 wherein the elongated pad member has a length of between about 0.70 inches and about 1.00 inches.

12. The machine of claim 2 wherein the pad member is retractable away from the outer surface of the mandrel assembly.

13. The machine of claim 1 wherein the mechanism comprises a belt system, and a portion of the belt that is moving linearly between two belt sheaves engages the cut length of film for ejection.

14. The machine of claim 13 wherein the belt portion is spaced from a primary external surface of the mandrel assembly, the mandrel assembly includes a secondary surface that protrudes from the primary surface, and the film is engaged between the belt portion and the secondary surface during ejection.

15. The machine of claim 14 wherein the secondary surface is a movable bearing surface.

16. The machine of claim 14 wherein the secondary surface is a stationary low friction surface material.

17. The machine of claim 13 wherein the belt portion moves in a linear direction that is skewed relative to a primary axis of the mandrel assembly such that the cut length of film is rotated as it is ejected from the mandrel assembly.

18. The machine of claim 17 wherein a skew angle of the linear direction relative to the primary axis is between about five degrees and about twenty-five degrees.

19. The machine of claim 13 wherein a length of the belt portion that contacts that film is between about 0.70 inches and about 1.00 inches.

20. A method of applying tubular film sleeves onto containers, the method comprising:
moving tubular film from a supply of tubular film over a mandrel assembly including a film cutter for cutting the tubular film to produce a tubular film sleeve sized for application to a container passing below the mandrel assembly;
contacting the tubular film sleeve with an eject mechanism that moves linearly while engaging the tubular film sleeve so as to push the tubular film sleeve off of a lower end of the mandrel assembly and onto the container.

21. The method of claim 20 wherein the eject mechanism moves in a linear direction that is skewed relative to a primary axis of the mandrel assembly such that the tubular film sleeve is also rotated as it is pushed off of the mandrel assembly.

22. The method of claim 21 wherein a skew angle of the linear direction relative to the primary axis is between about five degrees and about twenty-five degrees.
